(19) United States
(12) Patent Application Publication
(10) Pub. No.: US 2024/0361525 A1
(43) Pub. Date: Oct. 31, 2024

(54) ARCHITECTURE TO ENHANCE IMAGE SHARPNESS OF WAVEGUIDE DISPLAYS

(71) Applicant: Applied Materials, Inc., Santa Clara, CA (US)

(72) Inventors: Kunal SHASTRI, Santa Clara, CA (US); David Alexander SELL, Santa Clara, CA (US)

(21) Appl. No.: 18/647,537

(22) Filed: Apr. 26, 2024

Related U.S. Application Data
(60) Provisional application No. 63/462,337, filed on Apr. 27, 2023.

(51) Int. Cl. G02B 6/122; G02B 5/18; G02B 6/12

(52) U.S. Cl. CPC G02B 6/1228; G02B 5/1823; G02B 2006/12107

(57) ABSTRACT

Embodiments described provide for waveguide combiners with phase matching regions. The waveguide includes one or more gratings. The one or more gratings includes grating structures disposed over a waveguide substrate. A phase matching region is disposed over the waveguide substrate between the one or more gratings and a waveguide region. The phase matching region includes a waveguide layer having a thickness varying from a first end to a second end of the waveguide layer, or a plurality of structures having depths therebetween. The one or more of the depths are different from each other, or at least two or more structures of the plurality of structures have a first duty cycle different than a second duty cycle of the plurality of structures.

### CROSS-REFERENCE TO RELATED APPLICATIONS

This application claims priority to U.S. Provisional Patent Application Ser. No. 63/462,337, filed on Apr. 27, 2023, which is herein incorporated by reference.

### BACKGROUND

### Field

Embodiments of the present disclosure generally relate to waveguide combiners. More specifically, embodiments described herein provide for waveguide combiners with phase matching regions.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhance or augment the environment that the user experiences. As an emerging technology, there are many challenges and design constraints with augmented reality. Therefore, there is a need for waveguide combiners with phase matching regions.

### SUMMARY

In one embodiment a waveguide is provided. The waveguide includes one or more gratings. The one or more gratings including grating structures are disposed over a waveguide substrate. A phase matching region is disposed over the waveguide substrate between the one or more gratings and a waveguide region. The phase matching region includes a waveguide layer having a thickness varying from a first end to a second end of the waveguide layer, or a plurality of structures having depths therebetween. The one or more of the depths are different from each other, or at least two or more structures of the plurality of structures have a first duty cycle different from a second duty cycle of the plurality of structures.

In another embodiment, a waveguide is provided. The waveguide includes a first grating and a second grating. The first grating includes first grating structures disposed over a waveguide substrate. The second grating includes second grating structures disposed over the waveguide substrate. A phase matching region is disposed over the waveguide substrate between the first grating and the second grating. The phase matching region includes a waveguide layer having a thickness varying from a first end to a second end of the waveguide layer or a plurality of structures having depths therebetween. The one or more of the depths are different from each other, or at least two or more structures of the plurality of structures have a first duty cycle different from a second duty cycle of the plurality of structures.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the disclosure and are therefore not to be considered limiting of its scope, as the disclosure may admit to other equally effective embodiments.

FIG. 1 is a schematic top view of a waveguide combiner according to embodiments described herein.

FIG. 2 is a schematic side view of a portion of a waveguide according to embodiments described herein.

FIG. 3 is a schematic side view of a portion of a waveguide according to embodiments described herein.

FIG. 4 is a schematic side view of a portion of a waveguide according to embodiments described herein.

FIG. 5 is a schematic top view of a portion of a waveguide according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to waveguide combiners. More specifically, embodiments described herein provide for waveguide combiners with phase matching regions.

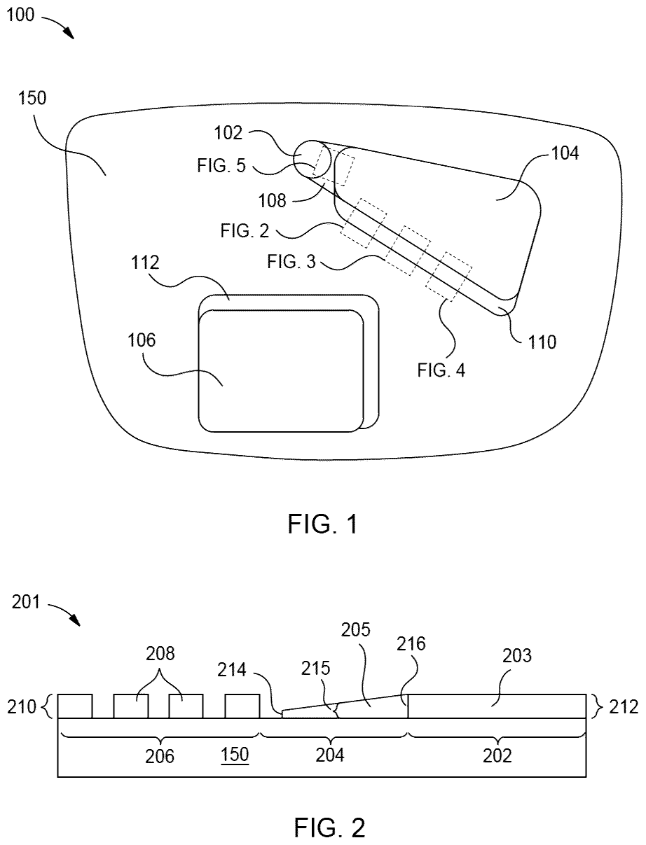

FIG. 1 is a schematic top view of a waveguide combiner 100 according to embodiments described herein. It is to be understood that the waveguide combiner 100 described below is an exemplary waveguide combiner. The waveguide combiner 100 includes an input coupling region 102, an intermediate region 104, and an output coupling region 106, and a waveguide substrate 150. The input coupling region 102 receives incident beams of light (a virtual image) having an intensity from a microdisplay. The incident beams of light undergo total-internal-reflection (TIR) and propagate in the waveguide combiner 100 in order to direct the virtual image to the intermediate region 104. The incident beams of light continue under TIR and propagate in the waveguide combiner 100 in order to direct the virtual image to the output coupling region 106 where the incident beams of light are out-coupled to the user. As the incident beams of light propagate in TIR in the waveguide combiner 100, some of the beams of light will be incident on the input coupling region 102, the intermediate region 104, and the output coupling region 106, while some of the beams of light will be incident on areas of the waveguide substrate 150 adjacent thereto.

The waveguide substrate 101 may be formed from any suitable material, provided that the waveguide substrate 101 can adequately transmit light in a selected wavelength or wavelength range and can serve as an adequate support for the waveguide combiner 100 described herein. Substrate selection may include substrates of any suitable material, including, but not limited to, amorphous dielectrics, non-amorphous dielectrics, crystalline dielectrics, silicon oxide, polymers, and combinations thereof. In some embodiments, which may be combined with other embodiments described herein, the waveguide substrate 101 includes glass, silicon (Si), silicon dioxide (SiO₂), germanium (Ge), silicon germanium (SiGe), indium phosphide (InP), gallium arsenide (GaAs), gallium nitride (GaN), fused silica, quartz, sapphire (Al₂O₃), silicon carbide (SiC), lithium niobate (LiNbO₃), indium tin oxide (ITO), or combinations thereof. In other embodiments, which may be combined with other embodiments described herein, the waveguide substrate 101 includes high-refractive-index glass. The high-refractive-index glass includes greater than 2 percent by weight of lanthanide (Ln), titanium (Ti), tantalum (Ta), or combinations thereof.

The waveguide combiner 100 further includes an input phase matching region 108, an intermediate phase matching region 110, and an output phase matching region 112. Each of the phase matching regions (e.g., the input phase matching region 108, the intermediate phase matching region 110, and the output phase matching region 112) reduces phase discontinuity between the beams of light incident on the grating regions (e.g., the input coupling region 102, the intermediate region 104, or the output coupling region 106) and the beams of light incident on the areas of the waveguide substrate 150 adjacent thereto. In turn, each of the phase matching regions reduces wave front aberrations and helps to create a sharper image as seen by the user by matching the phase between the grating regions and the areas of the waveguide substrate 150 adjacent thereto. As shown in FIG. 1, the input phase matching region 108 is located adjacent to the input coupling region 102 and the intermediate region 104. The intermediate phase matching region 110 is located adjacent to the intermediate region 104. The output phase matching region 112 is located adjacent to the output coupling region 106.

A device material of the structures of the gratings and the waveguide layer of the phase matching regions and the waveguide regions described herein include the same device material. The device material includes, but are not limited to, one or more of silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), or silicon carbon-nitride (SiCN) containing materials.

FIG. 2 is a schematic side view of a portion 201 of a waveguide combiner 100 according to embodiments described herein. The portion 201 includes a grating 206. The grating 206 includes grating structures 208 disposed over the waveguide substrate 150. The grating 206 may be one of the input coupling region 102, the intermediate region 104, or the output coupling region 106. The grating structures 208 have a grating structure height 210 from the waveguide substrate 150 to the upper surface of the structures 208.

A phase matching region 204 is disposed over the waveguide substrate 150 between the grating 206 and a waveguide region 202. The waveguide region 202 includes a waveguide region layer 203. The waveguide region layer 203 has a waveguide region layer height 212. The waveguide region layer 203 is disposed over portions of the waveguide substrate 150 without, i.e. not having, the grating 206 or the phase matching region 204. The phase matching region 204 includes a waveguide layer 205. The waveguide layer 205 has a thickness 215 varying from a first end 214 to a second end 216 of the waveguide layer 205. The thickness 215 of second end 216 of the waveguide layer 205 is the same as the grating structure height 210. The thickness 215 at the first end 214 is less than the grating structure height 210. The thickness 215 of second end 216 of the waveguide layer 205 is the same as the grating structure height 210. The thickness 215 at the first end 214 is less than the grating structure height 210. The waveguide layer 205 is continuous from the first end 214 to the second end 216. In embodiments with the waveguide layer 205 adjacent to the waveguide region 202, the second end 216 of the waveguide layer 205 contacts the waveguide region layer 203.

In one embodiment, which can be combined with other embodiments described herein, the phase matching region 204 is located between the waveguide region 202 and the grating 206, as shown in FIG. 2. In another embodiment, the phase matching region 204 is located between two gratings 206, as shown in FIG. 5. The phase matching region 204 reduces phase discontinuity between the grating 206 and the waveguide region 202. In turn, the phase matching region 204 reduces wave front aberrations and helps to create a sharper image as seen by the user by matching the phase between the grating 206 and the waveguide region 202. A device material of the grating structures 208 of the grating 206, the waveguide layer 205 of the phase matching region 204, and the waveguide region layer 203 of waveguide region layer 202 is the same.

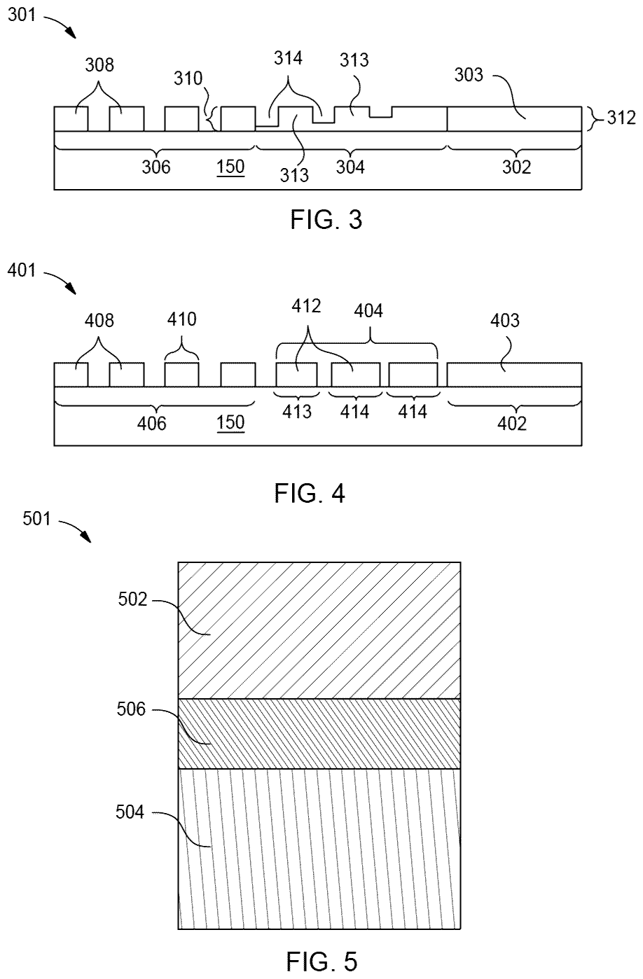

FIG. 3 is a schematic side view of a portion 301 of a waveguide combiner 100 according to embodiments described herein. The portion 301 includes a grating 306. The grating 306 includes grating structures 308 disposed over the waveguide substrate 150. The grating 306 may be one of the input coupling region 102, the intermediate region 104, or the output coupling region 106. The grating structures 308 have a grating structure height 310.

A phase matching region 304 is disposed over the waveguide substrate 150 between the grating 306 and a waveguide region 302. The waveguide region 302 includes a waveguide region layer 303. The waveguide region layer 303 has a waveguide region layer height 312. The waveguide region layer 303 is disposed over portions of the waveguide substrate 150 without, i.e. not having, the grating 306 or the phase matching region 304. The phase matching region 304 includes a plurality of waveguide structures 313. The plurality of waveguide structures 313 have depths 314 formed therebetween. In one embodiment, which can be combined with other embodiments described herein, one or more of the depths 314 are different from each other.

In one embodiment, which can be combined with other embodiments described herein, the phase matching region 304 is located between the waveguide region 302 and the grating 306, as shown in FIG. 3. In another embodiment, the phase matching region 304 is located between two gratings 306, as shown in FIG. 5. The phase matching region 304 reduces phase discontinuity between the grating 306 and the waveguide region 302. In turn, the phase matching region 304 reduces wave front aberrations and helps to create a sharper image as seen by the user by matching the phase between the grating 306 and the waveguide region 302. The depth 314 of second end of the waveguide layer 305 less than the grating structure height 310. The depth 314 at the first end is less than the grating structure height 310. A device material of the grating structures 308 of the grating 306, the waveguide layer 305 of the phase matching region 304, and the waveguide region layer 303 of waveguide region layer 302 is the same.

FIG. 4 is a schematic side view of a portion 401 of a waveguide combiner 100 according to embodiments described herein. The portion 401 includes a grating 406. The grating 406 includes grating structures 408 disposed over the waveguide substrate 150. The grating 406 may be one of the input coupling region 102, the intermediate region 104, or the output coupling region 106. The grating structures 408 have a grating structure duty cycle 410 as defined as the width of the recess between adjacent grating structures in the direction of the surface of the substrate divided by the sum of the width of the recess between adjacent grating structures in the direction of the surface of the substrate and the width of an adjacent grating structure 408 in the direction of the surface of the substrate. The sum of the width of the recess between adjacent grating structures in the direction of the surface of the substrate and the width of an adjacent grating structure 408 in the direction of the surface of the substrate is also known as the grating period.

A phase matching region 404 is disposed over the waveguide substrate 150 between the grating 406 and a waveguide region 402. The waveguide region 402 includes a waveguide region layer 403. The waveguide region layer 403 is disposed over portions of the waveguide substrate 150 without, i.e. not having, the grating 406 or the phase matching region 404. The phase matching region 404 includes a plurality of waveguide structures 412. In one embodiment, which can be combined with other embodiments described herein, at least two or more structures of the plurality of waveguide structures 412 have a first duty cycle 414 different than a second duty cycle 413 of the plurality of waveguide structures 412.

In one embodiment, which can be combined with other embodiments described herein, the phase matching region 404 is located between the waveguide region 402 and the grating 406, as shown in FIG. 4. In another embodiment, the phase matching region 404 is located between two gratings 406, as shown in FIG. 5. The phase matching region 404 reduces phase discontinuity between the grating 406 and the waveguide region 402. In turn, the phase matching region 404 reduces wave front aberrations and helps to create a sharper image as seen by the user by matching the phase between the grating 406 and the waveguide region 402. A device material of the grating structures 408 of the grating 406, the waveguide layer 405 of the phase matching region 404, and the waveguide region layer 403 of waveguide region layer 402 is the same.

FIG. 5 is a schematic top view of a portion 501 of a waveguide combiner 100 according to embodiments described herein. The waveguide combiner 500 includes a first grating 502, a second grating 504, and a phase matching region 506 located therebetween. The first grating 502 and the second grating 504 may be one of the input coupling region 102, the intermediate region 104, or the output coupling region 106. A device material the first grating 502, the second grating 504, and the phase matching region 506 is the same.

While the foregoing is directed to embodiments of the present disclosure, other and further embodiments of the disclosure may be devised without departing from the basic scope thereof, and the scope thereof is determined by the claims that follow.

What is claimed is:

1. A waveguide, comprising:
one or more gratings, the one or more gratings comprising grating structures disposed over a waveguide substrate; and
a phase matching region disposed over the waveguide substrate between the one or more gratings and a waveguide region, the phase matching region comprising at least one of:
a waveguide layer having a thickness varying from a first end to a second end of the waveguide layer; or
a plurality of structures having depths therebetween, wherein:
one or more of the depths between the plurality of structures are different from each other; or
at least two or more structures of the plurality of structures have a first duty cycle different than a second duty cycle of the plurality of structures.

2. The waveguide of claim 1, wherein the waveguide region is disposed over portions of the waveguide substrate adjacent to at least one of the one or more gratings or the phase matching region.

3. The waveguide of claim 1, wherein the one or more gratings are one of an input coupling region, an intermediate region, or an output coupling region.

4. The waveguide of claim 1, wherein a waveguide region layer is disposed over the waveguide region.

5. The waveguide of claim 4, wherein the waveguide region layer has a thickness equal to the thickness of the first end of the waveguide layer.

6. A waveguide, comprising:
a first grating, the first grating comprising first grating structures disposed over a waveguide substrate;
a second grating, the second grating comprising second grating structures disposed over the waveguide substrate; and
a phase matching region disposed over the waveguide substrate between the first grating and the second grating.

7. The waveguide of claim 6, the phase matching region further comprising a waveguide layer having a thickness varying from a first end to a second end of the waveguide layer.

8. The waveguide of claim 6, the phase matching region further comprising a plurality of structures having depths therebetween.

9. The waveguide of claim 8, the depths further comprising one or more of the depths are different from each other.

10. The waveguide of claim 8, the depths further comprising at least two or more structures of the plurality of structures having a first duty cycle different than a second duty cycle of the plurality of structures.

11. The waveguide of claim 6, wherein the first grating and the second grating are one of an input coupling region, an intermediate region, or an output coupling region.

12. The waveguide of claim 7, wherein a phase matching region is located between the first grating and the second grating.

13. A waveguide combiner, comprising:
an input coupling region receiving incident beams of light;
an intermediate region;
an output coupling region;
an input phase matching region;
an intermediate phase matching region;
an output phase matching region; and
a waveguide substrate.

14. The waveguide combiner of claim 13, wherein the incident beams direct a virtual image to the intermediate region.

15. The waveguide combiner of claim 14, wherein the incident beams direct the virtual image to the output coupling region.

16. The waveguide combiner of claim 13, wherein the input phase matching region, the intermediate phase matching region, and the output phase matching region reduce phase discontinuity between beams of light incident on the input coupling region, the intermediate region, or the output coupling region.

17. The waveguide combiner of claim 13, wherein the input phase matching region is located adjacent to the input coupling region and the intermediate region, the intermediate phase matching region is located adjacent to the intermediate region, and the output phase matching region is located adjacent to the output coupling region.

18. The waveguide combiner of claim 13, wherein one or more of the input coupling region, the intermediate region, or the output coupling region are gratings.

19. The waveguide combiner of claim 18, wherein the gratings include grating structures disposed over the waveguide substrate.

20. The waveguide combiner of claim 13, wherein the input phase matching region, the intermediate phase matching region, and the output phase matching region include a plurality of waveguide structures having depths formed therebetween.
